(19) United States
(12) Patent Application Publication
(10) Pub. No.: US 2006/0242607 A1
(43) Pub. Date: Oct. 26, 2006

(54) User interface

(75) Inventor: James Allan Hudson, Fleetwood (GB)

Correspondence Address: MERCHANT & GOULD PC, P.O. BOX 2903, MINNEAPOLIS, MN, 55402-0903, US

(73) Assignee: UNIVERSITY OF LANCASTER, Bailrigg (GB)

(21) Appl. No.: 10/560,403

(22) PCT Filed: Jun. 14, 2004
(86) PCT No.: PCT/GB04/02538

§ 371 Date: Jun. 21, 2006

(30) Foreign Application Priority Data
Jun. 13, 2003 (GB) 0313845.0
Jun. 13, 2003 (GB) 0313848.4
Jun. 13, 2003 (GB) 0313847.6

(51) Int. Cl. G06F 3/00

(52) U.S. Cl. 715/863

(57) ABSTRACT

A user interface for a display of an electronic device is described. The user interface includes a background layer for displaying an interface and at least a first animated control element overlaid on the back ground layer. The control element has a plurality of functions associated with it. Each of said functions is executable by making a 2D gesture associated with a one of said plurality of functions in a region of the user interface associated with the control element. A device including such an interface and computer code for providing such an interface are also described.

The present invention relates to a user interface, and in particular to a user interface with a gesture based user interaction, and devices including such a user interface, and computer program code and computer program products providing such an interface.

The present invention addresses problems with user interfaces and in particular user interfaces for devices with small displays, such as mobile computing devices, PDAs, and cellular communications devices, such as mobile telephones and smart phones and similar. However, the benefits of the invention are not limited to such devices and the invention can also be of utility in connection with desk top, lap top or note book computing devices and for devices with large displays, such as data boards. Further the invention is not limited to utility with electronic devices whose primary function is computing, and can be utilised with any electronic device having a display via which a dialogue can be carried out with a user.

A difficulty with designing graphical interfaces for small displays, such as touch screen displays, is that a regular text document has to be divided into very small pages, making comprehension awkward. An additional problem is control elements take up precious display area, making the view of a document ever smaller. One approach is to reduce the size or number of control elements, so as to free up usable display area. However this effects the usability of an interface. Hence a problem is to maintain a reasonable sized interface without affecting its usability.

The difficulty in constructing good solutions to interaction, particularly for handheld and portable devices with small graphical displays, has spawned much interest from researchers specializing in multi modal and tangible forms of interaction. Some of the previous approaches to command and text input will be reviewed to set the benefits of the present invention in suitable perspective.

Many proposed solutions to the handheld command and/or text input problem fail to appreciate the true obstacles of preserving portability and compactness, ease and convenience of interaction and the deft conservation of screen real estate. In order to illustrate the problem of text input for handheld devices, some previous approaches will be discussed.

Plug-in keyboards, or the laser projected variety, such as the virtual laser keyboard provided under the name IBIZ, would seem to offer a solution to the problem of easily entering text on small devices. However, this approach reduces the portability of a device and requires a user to carry ancillary equipment. The integration of a full size keyboard into a device design compromises the necessary limit on size and ergonomics of use, not to mention the portability of the device, as a flat surface is required to use the keyboard.

A different approach is the chorded keyboard, more usefully implemented for handheld devices as a device held in the hand. However, there is a significant learning overhead due to the user having to learn key combinations to select each letter or number. This approach does provide high one handed text input rates of, for example, more than 50 words per minute. However, with current implementations the need to hold a chorded keyboard in one hand, does affect the ergonomics of interaction. A modified approach would be to integrate the keyboard into the device itself.

Similar to the chorded keyboard is the T9 predictive text found on many mobile phones. Entering a series of characters using keys generates a list of possible words. This approach does pose difficulties if the intended word is not found in the dictionary or the intended word is at the bottom of the list of suggestions.

Clip on keyboards may appear to provide a usable text entry facility for small devices, at least on physical grounds. However, they do add bulk, and thus adversely affect the trade-off between size, portability and practicality. An alternative to the clip on is the overlay keyboard. Though these do not increase the size of the device, they do have usability implications. The overlay keyboard is essentially no different to a soft keyboard (discussed below), and can be a sticker that permanently renders the utility of a portion of the display for text input only, thereby restricting the use of an already limited resource.

The soft keyboard is not substantially different from the clip-on keyboard, except that it is implemented as a graphical panel of buttons on the display rather than a physical sticker over the display. The soft keyboard has the added hindrance of consuming screen display area, as does the overlay approach. However, as the soft keyboard is temporary, it does permit the user to free-up display area when required. While the soft keyboard approach appears to be a commonly accepted solution, it is a solution that is greedy in terms of screen area.

Another approach based on the standard keyboard is one that uses a static soft keyboard placed in the background of the display text. A letter is selected by tapping the appropriate region in the background. This solution permits manual input and does preserve some screen real estate. However, the number of available controls and hence redundancy is limited due to the necessary larger size of the controls, required to make the keys legible through the inputted text. This limit on the number of controls necessitates an awkward need to explicitly switch modes for numbers, punctuation and other lesser used keys. Another drawback is the slight overhead in becoming accustomed to the novel layout.

Attempts have been made to improve the soft keyboard approach, but these attempts are still subject to the drawbacks already describe with this approach. Further, they are subject to a learning overhead imposed by remodelling the keyboard layout. In a Unistroke keyboard, all letters are equidistant, thus eliminating excessive key homing distances. A Metropolis keyboard is another optimised soft keyboard layout, which has been statistically optimised for single finger input. Efficiency is improved by placing frequently used keys near the centre of the keyboard. While both approaches can be effective, but both impose a learning overhead due to a new keyboard layout. The user must expend considerable effort to become familiar with the keyboard for relatively slim rewards, not to mention the overhead inherent with soft keyboards, such as the consumption of screen real estate.

Handwriting recognition was for some time the focus of PDA text input solutions. However, evaluation has revealed that gesture recognition for text input is balky and slower, some 25 wpm at best, than that of other less sophisticated approaches, such as the soft keyboard. A problem with handwriting, and similar approaches using 2D gesture interaction, such as Graffiti, is one of learnability, slow interaction and skill acquisition. A problem with handwritten input is the need, and time expended, to write each letter of a word. Irrespective of whether this is consecutively, or all at once, the user must still write the whole thing out. In contrast a keyboard based solution requires merely the pressing of a button.

In addition to this difficulty, as with the standard soft keyboard, text input requires the use of a stylus, thus occupying the user's free hand (i.e., the need to hold the PDA or device) when entering text. The learning curve of this approach is steep due to the need to learn an alphabet of gestures and the saving in real estate is not so apparent, since some approaches require a large input panel.

Another, less well known, solutions to the problems of text entry for small devices is the use of a mitten. Sensors in the hand units measure the finger movements, while a smart system determines appropriate keystrokes. While this approach is an intriguing solution, a problem with it is the need to carry around a mitten that is nearly as big as the device itself. Further, a mitten may not be appealing to the user and the sensors on these devices can be bulky affecting freedom of movement.

A further approach is known as Dynamic dialogues, which, when applied to limited display size, provides a data entry interface which incorporates language modelling. The user selects strings of letters as they progress across the screen. Letters with a higher probability of being found in a word are positioned close to the centre line. Although the dynamic dialogue approach makes use of 2D gestures, these are supported by affordance mechanisms and they have been kept simple for standard interaction, making them readily learnable. Users can achieve input rates of between 20-34 words per minute, which is acceptable when compared with typical one-finger keyboard touch screen typing of 20-30 words per minute. However, the input panel for text entry consumes around 65% of the display, leaving as little as 15% remaining for the text field. The approach does not improve on the constraints of limited display area or on text input rates. What it does do is require the user to become familiar with a new technique for little benefit.

The present invention therefore aims to provide an improved user interface for entering commands and/or text into a device. The invention addresses some of the above mentioned, and other problems, as will become apparent from the following description. The invention applies superimposed animated graphical layering, (sometimes referred to herein as visual overloading) combined with gestural interaction to produce an overloaded user interface. This approach is particularly applicable to touch screen text input, especially for devices with limited display real estate, but is not limited to that application nor to touch screen display devices.

According to a first aspect of the present invention, there is provided a user interface for a display of an electronic device, the user interface including a background layer and at least a first control element overlaid on the back ground layer. The control element has a plurality of functions associated with it. Each of said functions can be selected, invoked or executed by making a 2D gesture associated one the functions in a region of the user interface associated with the control element. The control element can be transparent.

In this way the amount of the displaying available for displaying information is increased, without reducing functionality as a user can easily select and execute a function or operation by simply making the appropriate 2D gesture over the control element.

The background layer can display an interface, work context or dialogue for an application with which the user is interacting via the interface. For example, the background layer can display text, a menu, any of the elements of a WIMP based interface, buttons, control elements, and similar, and any combination of the aforesaid.

The control element can be animated. In particular, the shape, size, form, colour, motion or appearance of the control element can be animated or otherwise varied with time. An animated control element helps a user to distinguish between the control element and background while still rendering the background easily viewable and readable by the user.

The control element can also move over a region or the whole of the background. Preferably the control element continuously moves over and repeats a particular path, track or trace. The path track or trace may be curved.

The control element can be opaque. The control element can be at least partially transparent. Parts of the control element can be opaque and parts of the control element can be partially or wholly transparent. Parts of the control element can be partially transparent and parts of the control element can be wholly transparent. The whole of the control element can be transparent at least to some degree. Alpha blending can be used to provide a transparent part of a control element or control element.

The control element can be any visually distinguishable entity or indicia. For example, the control element can be a character, letter, numeral, shape, symbol or similar of any language, or combination or string thereof. The control element can be an icon, picture, button, menu, tile, title, dialogue box, word or similar, and any combination thereof.

The 2D gesture can be a straight line or a curved line, or combination of curved and/or straight portions. The 2D gesture can be a character, letter, numeral, shape, symbol or similar of any language, or combination or string thereof. The 2D gesture can be continuous or can have discrete parts.

The control element can be a word. Different characters or groups of characters of the word can be animated separately. The word can be a polysyllabic word and each individual syllable can be animated.

The control element can be a button or menu title. The button or menu title can bear an indicia, such as a symbol, word, icon or similar (as mentioned above) indicating a menu or group of functions or operations associated with the button and making the 2D gesture can select of execute a function from the menu or group.

A help function can be associated with the control element. Making a help 2D gesture can cause help information relating to the functions associated with the control element to be displayed in the user interface. The information can be displayed adjacent and/or around the control element. Preferably the help 2D gesture has substantially the shape of a question mark.

The control element can be visually transparent. The control element can have a transparency of less than substantially 40%, preferably less than substantially 30%, more preferably less than 20%. The control element can have a transparency in the range of substantially 10% to 40%, substantially 10% to 30%, or substantially 10% to 20%. Low levels of visibility for the control elements enhance visibility of the background, but the animation and/or motion of the control elements allows a user to reliably identify the overlaying control element.

The user interface can include a plurality of animated control elements. Each control element can be associated with a different region of the user interface. Each control element can be associated with a different group or set of functions, operations or commands. Some of the individual operations, functions or commands can be common to different groups. The 2D gestures that can be used to select and/or execute a function, operation or command can be the same or different for different control elements.

The first control element can be of a first type and a second of the plurality of control elements can be of a second type different to the first type. The type of a control element can be any of: its animation; its movement; or other attribute of its visual appearance, such as those mentioned above, e.g. a word, icon, symbol etc.

The plurality of control elements can between them provide a keyboard. Each of the plurality of control elements can have a different group or set of characters or letters associated with them. The keyboard can have a plurality of regions. Each region can have a plurality of control elements associated with it. A first control element can have a letter or letters associated with it and/or a second control element can have a numeral or numerals associated with it and/or a third control element can have a symbol, symbols, or formatting function, e.g. tab, space or similar, associated with it. The function, command or operation associated with the control element can be to display selected entity on the background.

The keyboard can have a standard layout. The keyboard can provide characters, letters or symbols in an alphabet of a language. The language can be any language, but is preferably the English language. The language can be a ideogram based language such as Chinese, Japanese or Korean. Preferably the keyboard includes all of the charters, symbols or letters of a language.

At least one of the control elements is associated with a plurality of characters. Each of the plurality of characters can have a respective 2D gesture associated therewith. The gesture can cause the character to be displayed on the background layer.

The control element can have a 2D gesture associated with it for carrying out a formatting function on a character associated with the control element. For example, the 2D gesture could cause the character to be displayed underlined, in bold or having a different size or font. The 2D gesture can be a continuous part of a 2D gesture used to select the character or can be a discrete gesture.

The control elements can be associated with a plurality of media player functions. Each of the media player functions can have a respective 2D gesture associated therewith for causing the media player function to be executed. The media player functions can include, play, stop, forward, reverse, pause, eject, skip and record.

The control element can be animated so as to have a three dimensional appearance

The control element can be animated so as to be more readily noticeable by peripheral vision. The control element can have an axis along which it is animated. The animation can be configured to progress, change or vary in a certain direction. The control elements animation can comprises variable thickness bars scrolling along an axis, or in a direction. The control element can rotate in a plane parallel to the background. The degree of rotation can be used to provide a dial in which the direction or animation provides a pointer of the dial. The animation of the control element can vary depending on its rotation, e.g. the speed of animation, the colour of animation, the size of components of the animation, the nature of the animation, and similar, including combinations of the aforesaid.

According to a further aspect of the invention, there is provided an electronic device including a display device, a data processing device and a memory storing instructions executable by the data processing device, or otherwise configuring the data processing device to display a user interface on the display according to any of the first aspect of the invention, and including any of the aforesaid preferred features of the user interface.

The display can be a touch sensitive display. This provides a simple pointer mechanism allowing a user to enter gestures using either a separate pointing device, such as a stylus, or a digit, or part of a digit, of the user's hand.

The device can further include a pointer device for making a 2D gesture on the user interface. Any suitable pointing device can be used, such as a mouse, joystick, joypad, cursor buttons, trackball, tablet, lightpen, laser pointer and similar.

The device can be a handheld device. The device can be a handheld device having a touch sensitive display and the device can be configured so that a user can make 2D gestures on the touch sensitive display with a digit of the same hand in which the device is being held. In this way one handed use of the device is provided.

The device can be a wireless telecommunications device, and in particular a cellular telecommunications device, such as a mobile telephone or smart phone or combined PDA and communicator device.

According to a further aspect of the invention, there is provided a computer implemented method for providing a user interface for a display of an electronic device, comprising displaying a background layer; displaying a control element associated with a plurality of functions over the background layer; detecting a 2D gesture made over a region of the user interface associated with the control element; and executing or selecting a function associated with the 2D gesture.

The method can include steps or operations to provide any of the preferred features of the user interface as described above.

A plurality of animated control elements can be displayed. The control elements can be animated and/or transparent.

Detecting a 2D gesture can comprise a gesture engine parsing the 2D gesture and generating a keyboard event corresponding to the 2D gesture.

The method can further comprise determining a location or region within the display or user interface in which the 2D gesture, or a part of the 2D gesture was made. The method can further include determining whether a control element is associated with the location or region. The method can further comprise determining whether the location or region, or control element, has a particular keyboard event associated with it. The method can include determining which command, function or operation to select of execute by determining if a region in which a gesture was made has a control element associated with it and if the keyboard event corresponding to the gesture corresponds to a one of the commands, operations or functions associated with the control element.

The method can further comprise determining whether a gesture is intended to activate a control element and if not then determining or selecting a function of the background layer to execute. Determining can include determining whether a time out has expired before a pointer movement event occurs.

The 2D gesture can be a help 2D gesture and the function associated with the 2D gesture can be a help function which displays information relating to the control element adjacent and/or around the control element.

The information relating to the control element can include a graphical indication of all or some of the 2D gestures associated with the control element and/or text explaining the functions and/or gestures associated with the 2D control element.

The control element can be associated with a menu or group of functions or data items and the 2D gesture can cause a one of the functions from the menu or group of functions to be executed or to select a one of the data items.

The plurality of control elements can between them provide a key board and the 2D gesture can cause a character, numeral, symbol or formatting control selected from the keyboard to be displayed on the background layer.

The control element can be a character string and preferably the character string is a word. The word can be a polysyllabic word and each syllable of the word can be separately animated.

According to a further aspect of the invention, there is provided computer program code executable by a data processing device to provide the user interface aspect of the invention or the computing device aspect of the invention or the method aspect of the invention. According to a further aspect of the invention a computer program product comprising a computer readable medium bearing computer program code according to the preceding aspect of the invention is provided.

An embodiment of the invention will now be described, by way of example only, and with reference to the accompanying drawings, in which:

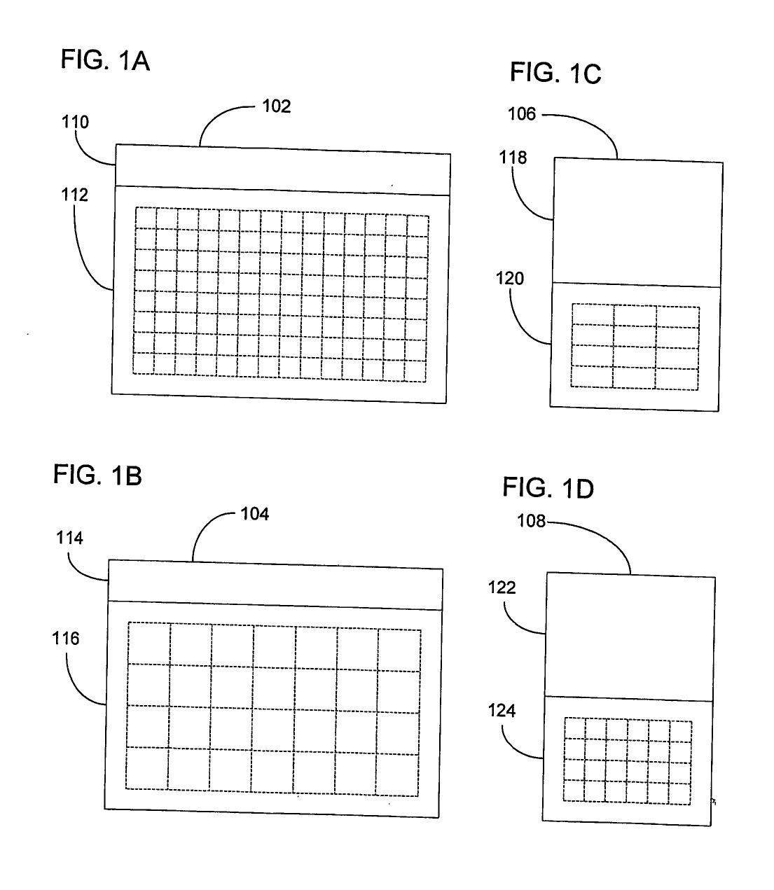

FIGS. 1A to 1D show graphical representations illustrating the constraints imposed by combining a keyboard and text area on a single display device;

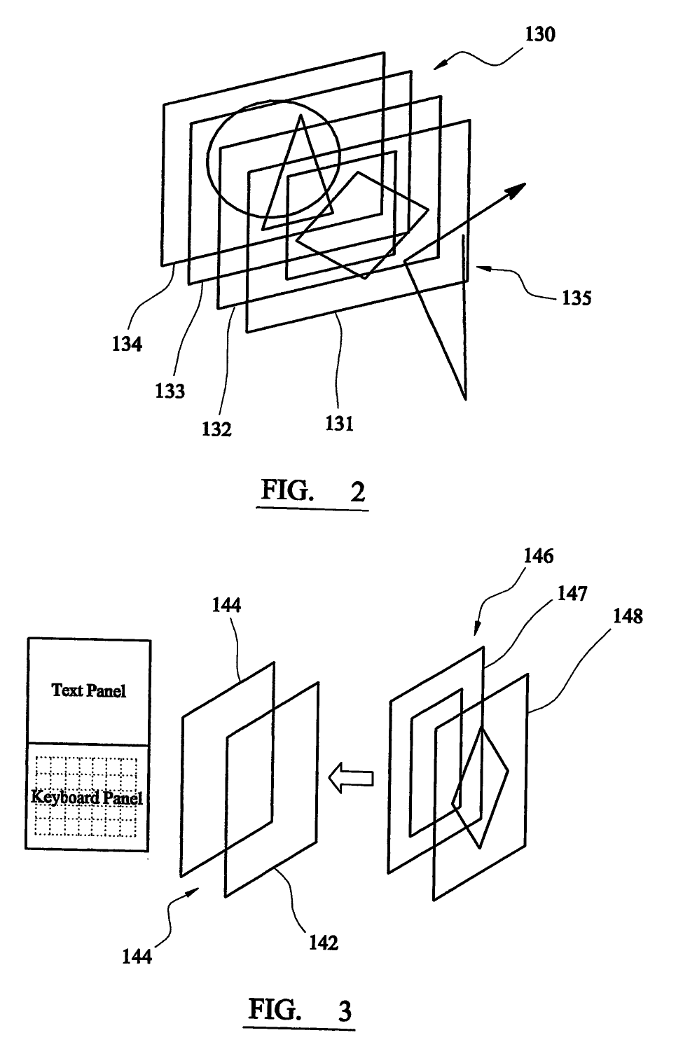

FIG. 2 shows a diagrammatic representation of a control element part of the user interface of the present invention and an associated 2D gesture;

FIG. 3 shows a diagrammatic representation of an overloaded user interface according to the present invention;

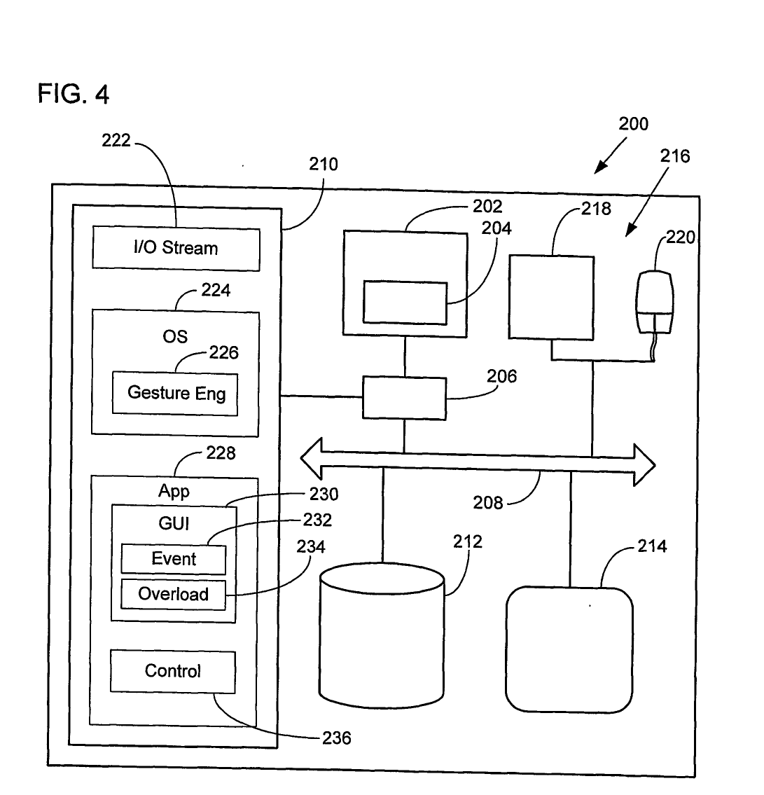

FIG. 4 shows a schematic block diagram of a device including a user interface according to the invention;

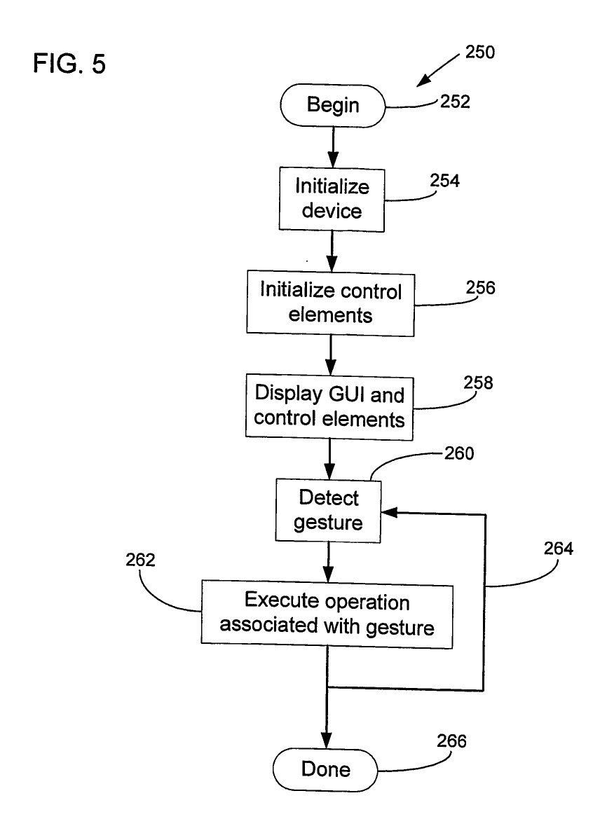

FIG. 5 shows a high level process flow chart illustrating a computer program providing the user interface according to the invention;

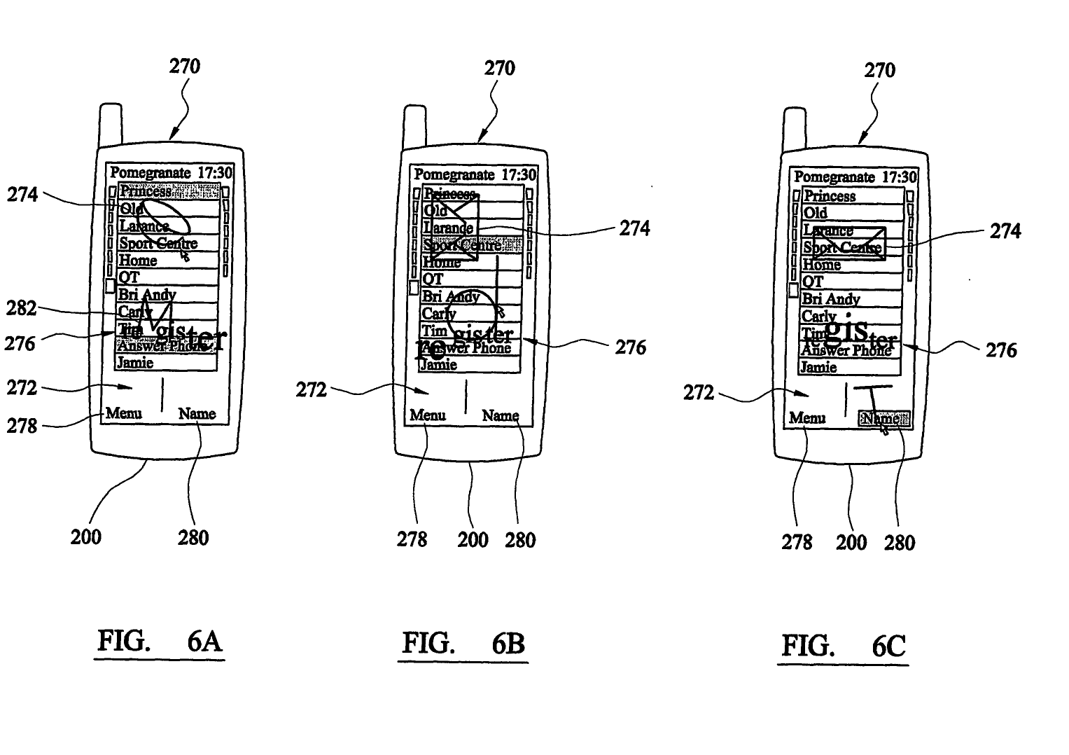

FIGS. 6A to 6C show a mobile phone including a user interface according to the present invention illustrating use of the user interface by a user;

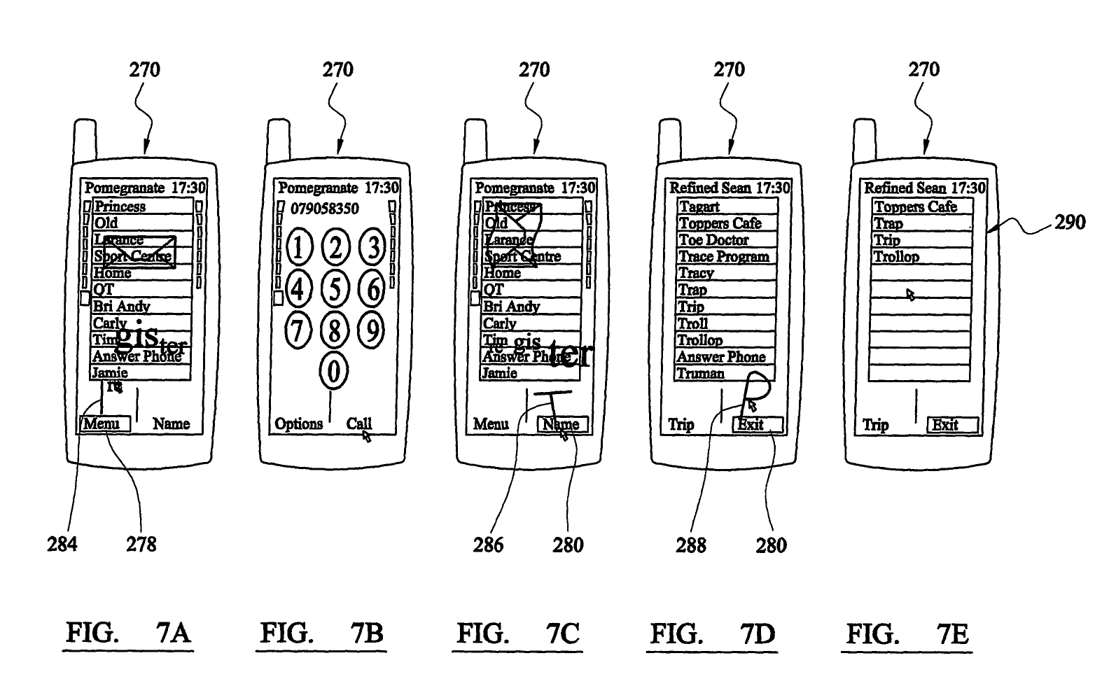

FIGS. 7A to 7E show different screens of the user interface of the phone shown in FIGS. 5A-5C illustrating further functionalities of the user interface of the invention;

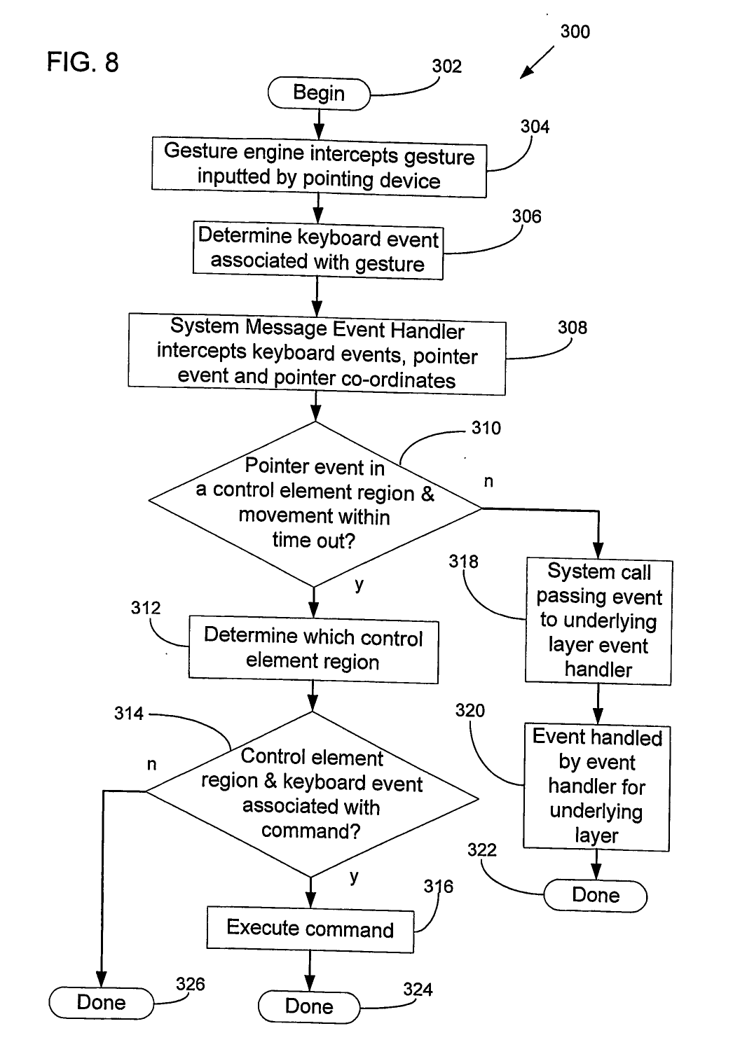

FIG. 8 shows a process flow chart illustrating parts of the flow chart shown in FIG. 7 in greater detail;

FIG. 9 shows a diagrammatic representation of a control element layer and background layer of the interface illustrating selection of a control element of the background layer;

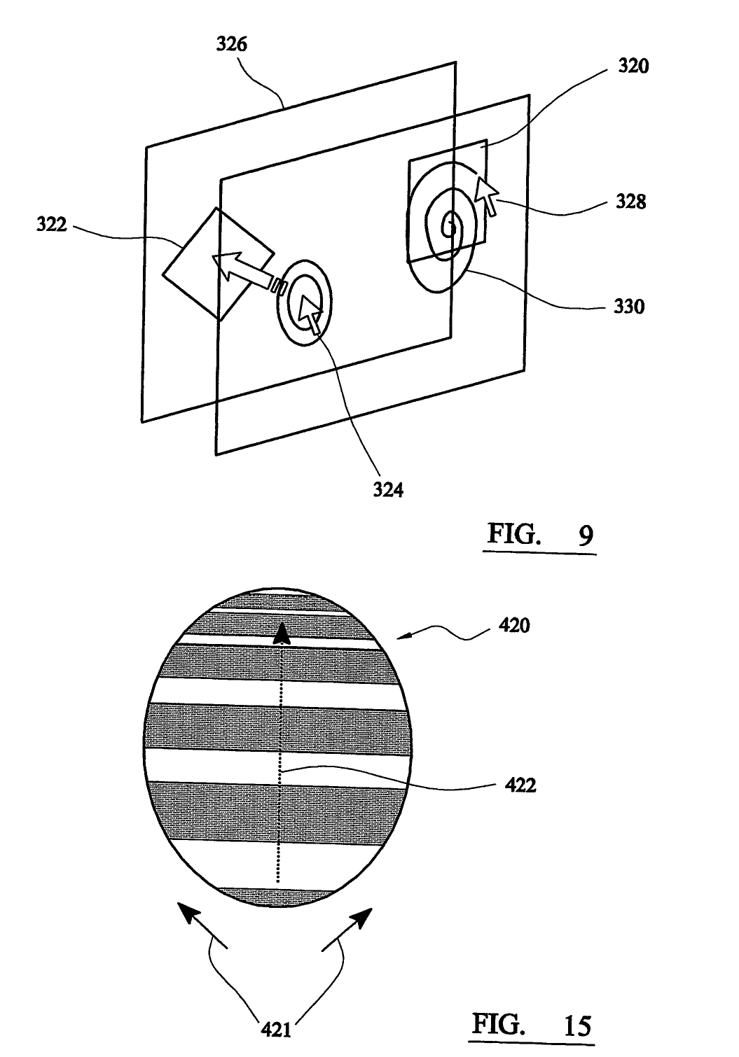

FIG. 10 shows the mobile phone shown in FIGS. 5A to 5C displaying a keyboard part of the user interface according to the present invention;

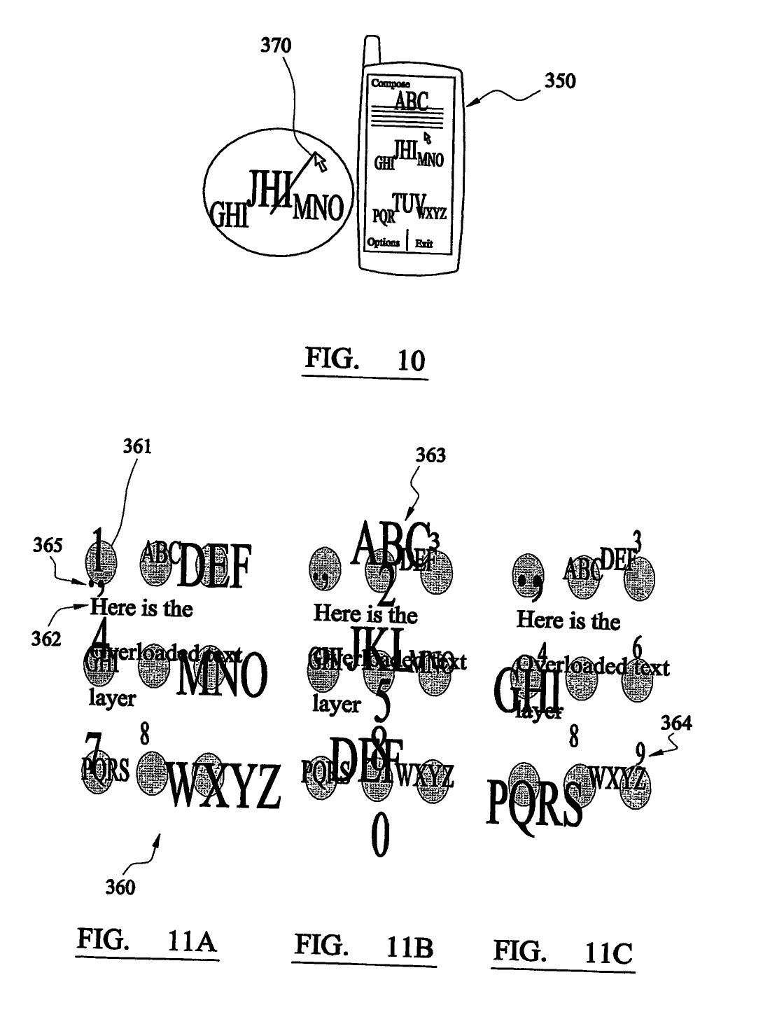

FIG. 11 shows the keyboard part of the interface shown in FIG. 10 in greater detail illustrating animation of the keyboard control elements;

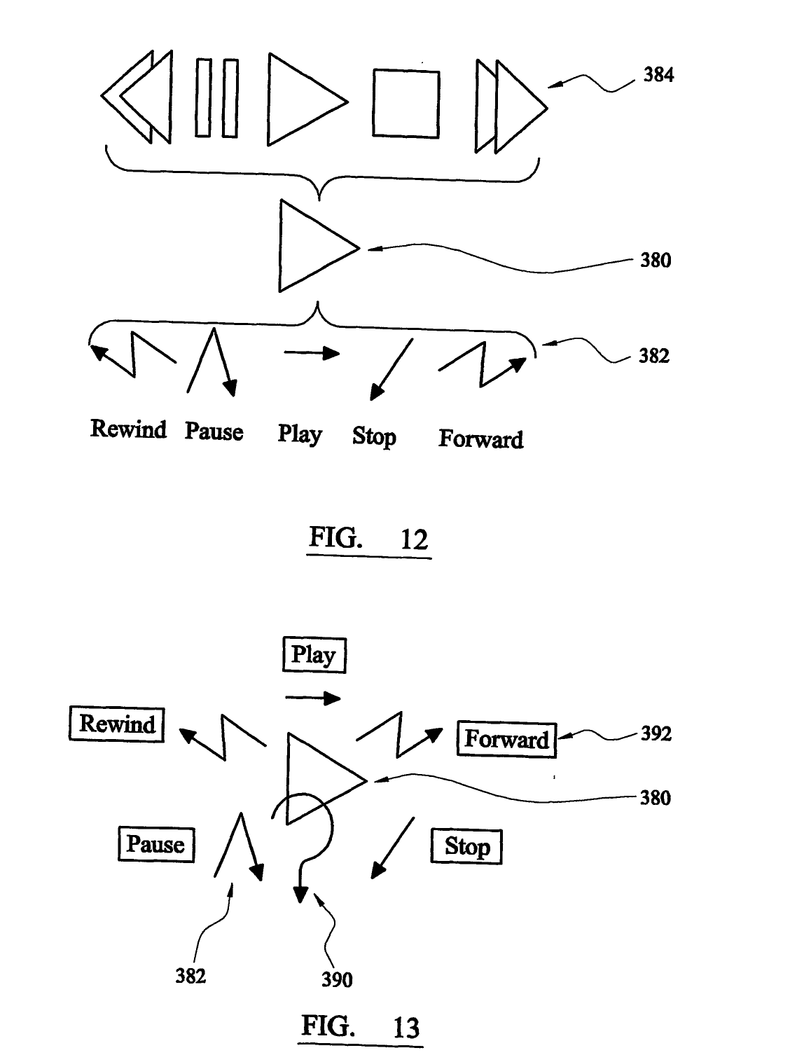

FIG. 12 shows a diagrammatic representation of the overloading of a set media player controls onto an overloaded control element part of the user interface of the invention and the associated 2D gestures;

FIG. 13 shows a graphical representation of a help function invoked by a 2D help gesture being applied to the overloaded control element of FIG. 12; and

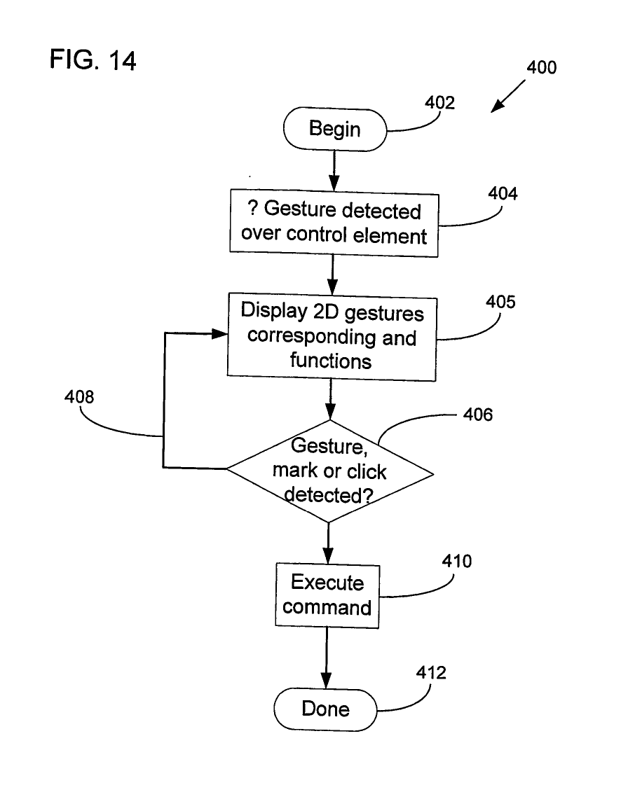

FIG. 14 shows a process flow chart illustrating execution of the help operation which has been invoked as illustrated in FIG. 13;

FIG. 15 shows an overloaded control element part of the user interface of the invention adapted for peripheral visibility.

Similar items in different Figures share common reference numerals unless indicated otherwise.

Before describing some preferred embodiments of the invention, a discussion of the requirements of a user interface, taken into account by the invention, will be provided Two examples can be used to illustrate the trade off between redundancy, ergonomics of use and visible display. A full screen keyboard allows direct manual interaction due to larger keys and a capacity for more keys but at the expense of display real estate.

Secondly, the standard split screen keyboard already limited in size, sacrifices redundant controls to permit larger keys and to make more visible display available. However, its small size results in the need to use an additional device, such as a stylus, which results in an approach that is difficult to use dextrously with the digits, i.e. fingers or thumbs.

The present invention appreciates that a problem with many text input solutions is the lack of appreciation of the true difficulty with handheld device text input. What is important is not the mechanism for inputting text in itself, but rather the consideration of the constraints on inputting, such as constraints on the available size of a text input panel and free display area.

With reference to FIGS. 1A to 1D there are respectively shown schematic illustrations of four keyboard and display area configurations 102, 104, 106 and 108 illustrating the constraints on a keyboard and display based user interface. The first configuration 102 has a small display area 110 and a large keyboard area 112, with small keys. The second configuration 104 has a small display area 114 and a large keyboard area 116, with large keys. The third configuration 106 has a large display area 118 and a small keyboard area 120, with large keys. The fourth configuration 108 has a large display area 122 and a small keyboard area 124, with small keys.

The layout of a command and text input mechanism is subject to some physical constraints which affect usability. In order to free up as much screen display as possible, input dialogues can be reduced in size (FIGS. 1C & 1D), which reduces the size of individual keys, making them more difficult to select. Increasing the number or redundancy of controls limits the space available. The size of keys is also subject to the number of keys on the keyboard. A large number of keys means less space per key (FIGS. 1A & 1D), or a smaller input text panel (FIGS. 1A & 1B). Alternatively, to minimise the display area used by the keyboard, and maintain a reasonable sized key, a designer can use menus or modes. Seldom used commands inevitably feature in submenus, which leads to a slow and awkward interaction approach.

These constraints are subject to the constraints defined in Fitts' law: a large dialogue is subject to a time overhead from increased hand travel, while smaller keys take up less space and merit a reduced hand travel, yet may incur a time overhead due to a fine motor control requirement in selecting a key. Overly small keys result in either unacceptable increases in error rates or unreasonably slow input rates for text input, due to awkwardness of selecting a key accurately. This suggests a larger keyboard should be favoured.

Ancillary pointers, such as a stylus, clip on keyboards and data gloves, can impede device usability. To interact with the device the user must either don the interaction accessory or, say, pick up a stylus, which in the case of many portable devices, ties up both hands. Therefore a more preferred interface would allow one handed use of the device and interface. However, the invention can also be used with a stylus, mouse or other pointer device.

Many prior small device text input approaches are not easily learned. The user expends time to learn numerous gestures and the different contexts they can be used in.

Drawing from the above evaluation of text input solutions a definition of the design requirements can be constructed, and which is fulfilled by the approach of the present invention, rather than merely further optimising on approaches that fail to address relevant issues such as screen real estate or convenience of use. For example the over engineered optimisations of conventional soft keyboards.

Consideration of the contributing factors in the design of interaction models for handheld and mobile devices leads to the following design considerations. Larger keys for manual interaction should be favoured over interaction aids. For example styluses, obstruct the freedom of a hand, posing a hindrance to handheld interaction. A good balance should be sought between redundancy in the number of visible input device features and availability of display area. An effective trade-off between display area, size of elements in the input panel, and usability should be provided. The approach should be easy to learn to use and understand or there should be a justifiable benefit for any learning overhead.

The user interface of the present invention is based on a system of interaction for entering commands, instructions, text or any other entry typically entered by a keyboard, pointing device (such as a mouse, track ball, stylus, tablet) or other input device, whereby a user can selectively interact with multiplexed or visually overloaded layers of transparent controls with the use of 2D gestures.

A control, or control element, can be considered functionally transparent in the sense that depending on the gesture applied to the control element, the gesture may propagate through the control element, and operate a further element on a background layer on which the control element is overlaid, or not. For example is a gesture is one that is associated with the control element, then a function associated with the control element may be executed. If the gesture is not one associated with the control element, e.g. a mouse ‘point and click’ gesture, then an operation associated with the underlying element of the backgroudn may be executed.

Visual transparency has been used previously in user interfaces, e.g. to display a partially visually transparent drop down menu over an application. This transparency has been used to optimize screen area, which can often be consumed by menu or status dialogues. The aim is to provide more visual clues in the hope the user will be less likely to lose focus of their current activity. However, this approach of using a layer of transparency to display a menu is done at the cost of obscuring whatever is in the background. This is not actually visual overloading, but rather a compromise between two images competing for limited display area.

In terms of visual appearance, the control element itself may be rendered and displayed either in wholly visually opaque form, or a partially visually opaque form, in which parts of the control element are opaque, but parts are transparent so that a user can see the underlying back ground layer. Additionally, the control element itself may be rendered and displayed in an at least partially visually transparent form, in which elements of the background layer can be seen through the control element.

2D gesture will generally be used herein to refer to a stroke, trace or path, made by a pointing device, including a user's digits, which has both a magnitude and a sense of direction on the display or user interface. For example, a simple ‘point and click’ or stylus tap will not constitute a 2D gesture as those events have neither a magnitude nor a direction. A 2D gesture includes both substantially straight lines, curved lines and a continuous line having straight and curved portions. Generally a 2D gesture will be a continuous trace, stroke or path. Further, for pointer devices allowing a 3D gesture to be carried out by a user, that 3D gesture can also result in an at least 2D gesture being made over the display device or user interface and the projection of the 3D gesture onto the display device or user interface can also be considered a 2D gesture, provided it amounts to more than a simple ‘point and click’ or ‘tap’ gesture.

Visual overloading is different from the use of static layered transparencies. An embodiment of the present invention renders an animated image or a transparent static image panel wiggling over a static background, which will visually multiplex or visually overload the overlapping images. The result is that a layer of controls appears to float over the interface without interfering with the legibility of the background. Overloading can be achieved to some degree using both approaches on an animated background.

The use of 2D of gestural input provides a mechanism by which to resolve the issue of layer interaction. Gesture activation has been used previously, for example with marking menus, but this approach only uses simple gradient stokes or marks and not with transparent control elements. Further, the present invention also makes use of more sophisticated gestures. The underlying principle of marking menus is to facilitate novice users with menus while offering experts a short cut of remembering and drawing the appropriate mark without waiting for the menu to appear. In contrast, the present invention uses 2D gestures for selective layer interaction. That is any one of a plurality of functions or operations (“layers”) associated with a particular control element can be selected by applying a particular 2D gesture to the control element which selects and activates the corresponding operation or layer.

This approach of incorporating 2D pointer gestures to activate commands associated with a control, provides the necessary additional context required beyond that of the restricted point and click approach. This enables the user to benefit from the added properties associated with an overloaded control by enabling the selective activation of a specific function related to a control contained in the layers.

For example, FIG. 2 shows a diagrammatic conceptual representation of an overloaded control element 130 which can be used in the user interface of the present invention. The control element itself has three “layers” 131, 132, 133 each of which is associated with a particular function graphically represented in FIG. 2 by a diamond, square and triangle respectively. The background or underlying layer 134 of the user interface, over which the control element is overlaid, can also have a function associated with it as illustrated by the oval shape in FIG. 2. The shapes shown in FIG. 2 are merely by way of distinguishing the different functions associated with the different layers and are not themselves visually displayed. Rather, a single control element is displayed over the back ground 134 layer and any one of the three functions associated with the control element can be selected by making the appropriate 2D gesture associated with the function over the control element.

For example, as illustrated in FIG. 2, by making a “T” shaped 2D gesture 135 over the part of the display associated with the control element 130, the triangle function i.e. the function associated with the third layer 133 of the control element can be selected and executed. For example, the control element could be an animated folder overlaid over the user interface for an application, such as a word processor or spread sheet application. Hence the folder will provide file handling functions. For example, the first layer could be associated with an open file function, the second layer with a close file function, the third layer with a delete file function and the application interface or background layer could be associated with some other function of the application, e.g. a printer operation.

Hence by executing an upper or lower case O, D or C shaped gesture over the control element the file open, file delete or file close operations can be called and executed.

In another example of an animated control element, more than one item can be represented in the same area as part of a media clip. For example, a triangle could change into a circle, and then into a rectangle and finally into a trapezium. This provides a thematic representation. The event of the change is remembered by a user, allowing all items to be recalled as one event contained in one area.

Hence, the present invention permits the intensive population of a display through the layering of control elements. This can be achieved without compromise in size of the inputted text panel or to the size of control elements. This approach effectively gets round the constraints described earlier by permitting background and subsequent layers to occupy the same screen real estate.

For example, FIG. 3 shows a diagrammatic representation of a user interface 140 combining an overloaded keyboard layer 142 over a back ground text display layer 144. Each of the keys of the keyboard can be in the form of a control element so that one of multiple operations can be carried out by making the appropriate 2D gesture over the region of the display associated with each key. For example a first 2D gesture on a key could cause a first character to be displayed on the underlying text layer, a second 2D gesture on the same key could cause a symbol to be displayed on the underlying text layer, and a third 2D gesture on the same key could cause a numeral to be displayed on the underlying text layer. Another control element 146 having two layers 147, 148 or functions associated with it can also be provided as an animated icon or symbol over the keyboard layer 142. For example control element 146 could have an ‘email’ function associated with the first layer 147 and a ‘send to printer’ function associated with the second layer 148. Hence, making the appropriate 2D gesture, e.g. an upper or lower case ‘e’ or ‘p’, over the display region associated with the control element 146 would select and execute a function to either e-mail or print the text on the underlying text layer 144.

Another benefit is the availability of real estate permitting larger controls, which are easier to locate, improving input rates and facilitate manual interaction.

Constraints of this approach are that too many elements can gradually cause the background to lose coherence, i.e. obscures the background, or the interface can become visually noisy if too many layers are added. However appropriately chosen layers permit a reasonable number of controls to be provided before this constraint takes effect.

Hence, the present invention eliminates the constraints between the size of the display and the input dialogue. In addition the redundancy of a control can be increased in a new way, by overloading the functionality of a control with a selection of gestures, thereby avoiding the use of obtrusive context menus.

An example embodiment of the invention in the form of a user interface for a cellular telecommunications device, such as a mobile telephone or mobile smart phone will now be described.

FIG. 4 shows a schematic block diagram of the computing parts of an electronic device 200. Those parts of the mobile phone device relating to its communications functions are conventional and are not shown so as not to obscure the nature of the present invention. Further the present invention is not limited to communications devices and can be used in any electronic device having a screen and which may benefit from the use of a user interface. Further, electronic devices are not considered to be limited only to devices primarily for computing, but is considered to include any and all devices having, or including, sufficient computing power to allow the present invention to be implemented and which may benefit from the user interface of the present invention, e.g. vehicle control systems, electronic entertainment devices, domestic electronic devices, etc.

Electronic device 200 includes a processor 202 having a local cache memory 204. Processor 202 is in communication with a bridge 106 which is in turn in communication with a peripheral bus 208. Bridge 206 is also in communication with local memory 210 which stores data and instructions to be executed by the processor 202. A mass storage device 212 is also provided in communication with the peripheral bus and a display device 214 also communicates with the peripheral bus 208. Pointing devices 216 are also provided in communication with the peripheral bus.

The pointing device can be in the form of a touch sensitive device 218, which in practice will be overlayed over display 214. Other pointing devices, generically indicated by mouse 220 can also be provided, such as a joy stick, joy pad, track ball and any other pointing device by which a user can identify positions and trace paths on the display device 214. For example in one embodiment, the display device 214 can be a data board and the pointing device can be a laser pointer with which a user can identify positions and trace paths on the data board. In other embodiments, the display device can be a three dimensional display device and the pointing device can be provided by sensing the positions of a user's hands or other body part so as to “point” to positions on the display device. In other embodiments, the position of a user's eyes on a display can be determined and used to provide the pointing device. However, in the following exemplary discussion, use of a mouse and a touch sensitive display will in particular be described. However, the invention is not intended to be limited to this particular embodiment.

Bridge 206 provides communication between the other hardware components of the device and the memory 210. Memory 210 includes a first area 222 which stores input/output stream information, such as the status of keyboard commands and the coordinates for pointer devices. A further region 224 of memory stores the operating system for the device and includes therein a gesture engine 226 which in use passes gestures entered into the device 200 by the pointing device 216 as will be described in greater detail below. A further area of memory 228 stores an application having a user interface according to the invention. The application 228 also includes code 230 for providing the graphical user interface of the invention. The user interface 230 includes a system event message handler 232 and code 234 for providing the overloaded control elements of the user interface 230. Application 228 also includes a control object 236 which provides the general logic to control the overall operation of the application 228.

The graphical user interface 230 can be a WIMP (Windows/icons/menus/pointers) based interface over which the control elements are overloaded. The system event message handler 232 listens for specific keyboard events, provided by the gesture engine 226. The system event message handler 232 also listens out for pointer events falling within a region of the display associated with a control element. The control element overloading module 234 provides a transparent layer, including the control elements, over the conventional part of the user interface. The transparent layer is implemented to allow the animated transparent control element to be rendered over the controls of the underlying or background layer. This can be achieved by either creating a window application using C# with an animated icon and specifying a level of opacity, or, as with some languages, such as J# and Java, a glass pane can be layered over a regular interface. Another way of implementing the animated control elements is to write the individual images comprising the animation (e.g. 25 frames) into different memory addresses in a memory buffer and then alpha-blending each of the frames from the memory over the background user interface layer.

In one embodiment, the application can be written in the Java programming language and executed using a Java virtual machine implementation, such as CREAM. A suitable gesture engine would be the Libstroke open source gesture engine. Alternatively, the overloaded control element module can be written in C#, for example, and using a low opacity setting in order to generate the animated control elements from the individual frames of the animation stored in memory, layered on top of bespoke standard controls, e.g. buttons.

With reference to FIG. 5, there is shown a high level process flowchart illustrating the computer implemented method 250 of operation of the device 200. Processing begins at step 252 and at step 254, the device is initialised, which can include initialising the gesture engine and otherwise preparing the device for functioning. Then at step 256, the control elements are initialised. This can include, for example, writing the frames for the animated control elements into memory areas, ready for display. Then at step 258, the underlaying background WIMP based user interface layer is displayed and the control elements are displayed over the background layer and their animations begun.

With reference to FIGS. 6A, 6B and 6C, there is shown a device 200 including an example of the user interface 270 of the present invention. The user interface 270 includes the background layer interface 272 and a first transparent animated control element 274, being an icon in the form of an envelope, and a second animated transparent control element 276 in the form of the word “register”. Each of the control elements, 274, 276 has a separate area of the user interface 270 associated with them.

FIGS. 6A, 6B and 6C show different screen shots of the same user interface so as to try and illustrate the animation of the control elements. The control elements are animated in the sense that their form, that is their appearance or shape, changes rather than merely moving over the display. However, the envelope control element 274 also moves over the display and similarly parts of the register control element 276 also move, and also vary in size. Each of the syllables of the register word changes separately that is the re syllable shrinks and grows and moves over the screen, the gis syllable shrinks and grows and moves over the screen and the ter syllable shrinks and grows and moves over the screen individually. However, these three elements together provide the overall control element 276.

As can be seen, the control elements 274, 276 are visually transparent as the background interface can be seen through the control elements. However, portions of the control elements, e.g. lines or individual characters, are themselves opaque, although in other embodiments those parts can also be transparent. Such animations are sometimes referred to as animated transparent Gifs in the art. A particular colour is made transparent and therefore using it as the background colour leaves an image clipped to the outline of the image. Another way of providing transparency is to use alpha-blending as is understood in the art.

Returning to FIG. 5, at step 260, the application detects whether a gesture has been applied to the user interface by a reporter device. In the illustrated embodiment, the device 200 has a touch sensitive screen and the interaction of a user's digit and the touch sensitive screen provides the pointer device. As illustrated in FIG. 6A, a user can tap the screen on the answer phone menu option of the underlying display and at step 262, the answer phone preparation can be executed. Process flow then returns, as illustrated by line 264, to step 260 at which a further gesture can be detected.

In order to invoke a one of the functions associated with a one of the control elements, the user makes a two dimensional gesture over the part of the user interface associated with the control element. Examples of the kinds of gestures and functions that can be executed will be provided by the discussion below. At some stage, the user can enter a gesture, either a conventional “point and click” gesture or 2D gesture in order to terminate the application and processing ends at step 226.

Commands can be executed in the user interface 270 with either standard “point and click” over a list item or the user can circumvent the intrusive hierarchical menu interaction approach by drawing a symbol (2D gesture) that starts over the relevant list item, which takes the user directly to the required dialogue or executes the desired command. Note that a stroke or 2D gesture is not restricted in size.

In addition, the overloaded layer of control elements is placed over the back ground menu items and control elements. A control or command from one of the layers within a region of the overloaded control can be selected with an appropriate gesture, thus disambiguating between competing controls and menu items. This permits a larger population of control elements with an adequate degree of redundancy, yet without compromise to the size of control elements or menu.

Simple animated black and white transparent gifs can be used to implement the control elements. Adequate performance is possible without alpha blending, although that can improve the user interface performance. Simple well chosen animations can be as important as the transparency.

Use of the interface 270 shown in FIGS. 6A to 7E various interaction scenarios will now be described to help explain the use and benefits of the interface of the invention. Interacting with the interface 270 is straightforward. As illustrated in FIG. 6A, the interface 270 in FIG. 6A has a list of frequently called numbers, two overloaded icons, one for messaging functions 274 and one for accessing ‘call register’ functions 276, with two gesture optimized control elements 278, 280 in the form of MENU and a NAME buttons respectively at the bottom of the display items.

To access a list element the user can either tap over it or gesture over it. For example, from the list of frequently used numbers (FIGS. 6A-6C) in the background interface, or a generated list of names, to access the details of a telephone number the user can click on the list element to access a submenu and select a ‘get details’ command from a list of options. Alternatively, as depicted in FIG. 6B, the user can simply draw a ‘d’ gesture starting over the list element, to go straight to the desired “list details” dialogue, in this case from the item marked ‘sport centre’.

In order to populate the display with more controls without compromise to manual interaction and the size of control elements in the background interface, the interface 270 has two overloaded icons or control elements 274, 276. Again, executing the appropriate gesture over a list item will execute a command. However, if the gesture starts over any list element that lies in a region associated with an overloaded control element icon and the gesture relates to that overloaded control element icon, then the command corresponding to that gesture is executed.

For example, drawing an ‘M’ stroke 282 over the ‘register’ overloaded icon 276, demonstrated in FIG. 6A, accesses a ‘Missed calls’ dialogue, whereas executing an ‘r’ gesture accesses a ‘Received calls’ dialogue.

This form of interaction model is not restricted to gestural interaction alone; more conventional ‘point and click’ or ‘tap’ gestures can be used when required, such as when dialling a number (see FIG. 7B), or, in FIG. 6A, where a double tap on a list element, rather than drawing a ‘d’, will call the selected number.

FIG. 7A illustrates the use of a 2D gesture driven button 278. Simply drawing an upward line 2D gesture 284 invokes the dialogue to enable dialling, avoiding any sub menu interaction (see FIG. 7B). Alternatively, simply tapping on the ‘Menu’ button 278 will enable the user to access a hierarchical menu, as in conventional interfaces, containing an option to ‘Dial a number’. This approach demonstrates the practical integration of the two modes of interaction.

FIG. 7C illustrates the use of the gesture activated “Name” button 280 to search for a given phone number. By drawing a ‘T’ shaped gesture 286 the list is set to and displays all elements that begin with the letter ‘T’ (FIG. 7D) and by drawing a ‘P’ shaped gesture 288 (middle) the list is further optimized to all elements that begin with the letter ‘T’ and contain the letter ‘P’. This approach drastically cuts down on executions for selecting a letter, whilst possessing a greater cognitive salience.

Drawing a symbol or tapping on the left of the list 290 executes a command; such as a double-click to call a number. Moreover, a symbol drawn on the right side of the list 290 will further refine the search to any remaining items that contain the desired letter. To access an element the users can again either tap on an item or gesture appropriately over the relevant list item.

With reference to FIG. 8, there is shown a flowchart illustrating the data processing operations carried out in order to handle the gesture based input to the user interface 270, and correspondingly generally to steps 260 and 262 of FIG. 5. The process 300 begins at 302 and at step 304, the gesture engine 226 intercepts gestures inputted by the pointing device, be it either a mouse entered gesture, touch screen entered gesture or from any other pointer device. The gesture engine passes the gesture and at step 306 determines a keyboard event which is associated with the gesture. The gesture engine outputs the keyboard event and at step 308, the user interface handler 232 intercepts the keyboard event and any pointer event and the current pointer co-ordinates. A pointer event, in this context, means a control command indicating that a pointer has been activated, e.g. a mouse down event or a “tap” event on a touch screen.

Then, step 310 discriminates between pointer events which should be passed through to the underlying interface and any pointer events that are intended to activate a control element. In particular, at step 310, it is determined, using the pointer co-ordinates, whether the pointer event has occurred within a region associated with a control element and if so, whether a gesture has begun within a time out period. Hence, if a pointer event is detected in a region associated with the control element but there is no motion of the pointer device to begin a 2D gesture within a fixed time period, then it is assumed that the command is intended for the underlying layer.

This first scenario is illustrated in FIG. 9 which shows a diagrammatic representation of distinguishing between pointer events intended to invoke an overloaded control element 320 or a control element of the underlying background layer 322. A static cursor 324 illustrates a mouse down or “tap” pointer event which is not followed by movement of the pointer and so a control element 322 in the underlying interface 326 is invoked.

Returning to FIG. 8, in this scenario, the user interface event handler 232 makes a system call passing the event to an event handler for the underlying layer 326. Then at step 320, the event handler for the underlying layer handles the event appropriately, e.g. by displaying a menu or other dialogue for executing an appropriate function. The process then completes at step 322.

Returning to step 310, if pointer movement is detected within the time out period, as illustrated by cursor 328 tracing a gesture 330 over a region of the user interface associated with the control element 320, then this pointer event is determined to be intended to invoke a overloaded control element.

Process flow proceeds to step 312 at which it is determined in which of the regions of the display associated with overloaded control elements, the pointer event has occurred. In this way, it can be determined which of a plurality of control elements, the 2D gesture is intended to have invoked. Then at step 314, it is determined which of the plurality of commands associated with the control element to select. In particular, it is determined whether the keyboard event corresponding to the gesture is associated with a one of the plurality of commands for the control element in that region and if so, then at step 316, the selected one of the plurality of commands, operations or functions is executed. Process flow then terminates at step 324.

If at step 314, it is determined that there is no command associated with the keyboard event corresponding to the gesture applied to the control element (e.g. there is no command associated with an ‘X’ shaped gesture) then process flow branches and the process 300 terminates at step 326.

Hence the overloaded control elements can be integrated seamlessly with WIMPS offering extended functionality by intercepting gestures but allowing standard point and click interaction to pass through the layers where they are handled in a conventional way. Such a user interface could interfere with drawing packages and text selection. However, the solution to this is to avoid conflicts using a small time delay to switch modes as described above or alternatively to use the right mouse key to activate gesture input.

It has been found that overloaded transparent control elements work with very low levels of transparencies, lower than the 30% opacity for static images typically suggested.

Other restrictions which exist and that can be avoided with good design are, the choice of colours conflicting with the background, and in the poor choice of animations which may result in difficulties selecting moving elements or distinguishing between layers. However, this is no more an overhead than in designing graphics for a standard interface or web site. Another restriction is animated controls can be obscured on a moving background, such as a media clip.

Referring back to FIG. 6A drawing a ‘C’ over the animated envelope opens a text input, or compose, dialogue 350 (FIG. 10) including an overloaded keyboard 360 shown in greater detail in FIGS. 11A, 11B and 11C., whereas an ‘I’ or ‘O’ would invoke an ‘Inbox’ and ‘Outbox’, respectively. The text input or “Compose” dialogue makes use of an overloaded layer of text, in the same style as that of the ‘Register’ overloaded control element icon 276 from the initial screen (FIGS. 6A-6C).

The keyboard 360 is implemented as a visually overloaded ISO keyboard layout (standard on mobile phones) and a number pad layered over the text. 2D gestures are incorporated using simple gradient strokes to select a letter and simple meaningful gestures to access other functions, such as numbers and upper case letters. An array of nine transparent green dots 361 provides a visual clue as to the nine areas on the display having control elements associated therewith. A group of transparent characters 363, e.g. three or four, in a first colour, e.g. blue, are animated and gradually grow and shrink in size as they move over a region of the display near the associated green dot. Animated numerals 364 are also associated with green dots and a transparent numeral in a second colour, e.g. blue, is similarly animated and grows and shrinks in size and moves around a region of the display near the associated green dot. Similarly animated punctuation marks 365, or other symbols or characters, are also associated with green dots and transparent symbols or characters are similarly animated and grow and shrink in size and moves around a region of the display near the associated green dot. The background layer then provides a display for the text 362 entered by the keyboard as described conceptually above with reference to FIG. 3. Hence, FIGS. 11A-11C show three frames of the animated keyboard 360 which is made up of a plurality of overloaded control elements each having an associated region.

To operate the keyboard (see FIG. 10), the user makes very simple gradient gestures, e.g. 370. To select a letter, a gradient stroke that starts over the selected button is performed. The centre point of a button is indicated with the green dot. The angle of a gesture supplies the context indicating which element is being selected. “L” would be selected with a right terminating gesture 370, as shown in FIG. 10, while “K” would be selected with a vertical up or downward stroke. To improve usability the “space” character is selected with a “right-dash” gesture, that can be executed anywhere on the display. Similarly a delete command is selected with a global “left-dash”.

To access lesser used functions, other than basic text input, the approach uses more elaborate 2D gestures such as selecting the number “5” with a meaningful and easily associated “n” gesture made in the region of the keyboard associated with the 5 numeral.

Other options include clearing text from the underlying display of the screen with a “C” gesture and a capital can be entered by drawing a “U” for upper case either immediately after, or as a continuous part of the 2D gesture for, the desired letter. The need to learn these associations does pose some learning overhead, however they can easily be learned especially using the help mechanism to be described below. Initially, this use of symbols is no less awkward than selecting a mode or menu option, however as the operation becomes familiar, it ceases to be as obtrusive as the other approaches. Point and click interaction is left alone to demonstrate that the approach could incorporate the T9 approach and could still use standard text interaction, such as with text editing in conventional graphical interfaces.

A further option is to use the length of a gesture to indicate the length of a word as part of a predictive text input mechanism. For example, the initial letter of a word is entered via the keyboard with the appropriate 2D gesture and then the user makes a gesture the length of which represents the length of the word. The predictive text entry mechanism then looks up words in its dictionary beginning with the initial letter and having a word length corresponding to the length of the gesture and displays those words as the predictions from which a user can select. The 2D gesture identifying the word length can have the general shape of a spike, or pule, similar to the trace generated by a heartbeat monitor.

The above approach to text input enables the user to enter text easily without complex combinations of keystrokes via an adequately sized soft keyboard. The benefits of this proposed design of a mobile phone interface include the following: practical manual touch screen interaction; the optimisation of limited screen real-estate; reduction in the cognitive overhead of a visual search schema, e.g., scanning for the correct button; a greater cognitive purchase afforded by the gesture interaction; reduction in the use of memory intensive sub menus, dialogues and excessively hierarchical command structures; the selection of a phone number within 1 to 3 executions, rather than the usual 3-8+; the selection of frequently used options all within one execution of a gesture, rather than multiple button presses; the incorporation of standard point and click interaction with the optimized gesture interaction exploits redundancy of interaction styles.

FIG. 12 shows a further overloaded control element 380 suitable for use in the interface of the invention. The control element can be used to operate a media player device and the single overloaded control element with a group of 2D gestures 382 can replace the five icons or control elements 384 conventionally required. The control element can be animated so that it changes its form and can move over a region of a display on which a user is focussed, eg the interface of an application such as a word processor. Hence the user can easily control a media player by executing an appropriate one of the 2D gestures 382 so as to invoke the rewind, forward, play, pause or stop functions without having to move their visual field from their current focus.

FIG. 13 shows a graphical illustration of a help function which can be invoked by executing a ‘?’ shaped 2D gesture 390 over a control element 380. A problem of gesture interaction is the steep learning curve, because of the need to be familiar with a multitude of gestures and their contexts. The present interface supports learnability by introducing a mechanism wherein an easily remembered “?” gesture will prompt the interface to display the gestures 382 associated with a control 380. In this way the user can become familiar with the system gradually, summoning help in context and when needed. This help functions also provides a mechanism to support goal navigation and exploration.

To improve the usability, after the help function has been invoked, then a function of the control element can be activated in a number of ways. The user can make the correct 2D gesture over the control element or can make a pint and click or tap gesture on text labels or buttons 392 which are also displayed adjacent the control element. In addition a straight-line gesture from the control element icon 380 to the label 392, can be used to execute the operation. The “?” shaped gesture may or may not require the “.”, and preferably does not, as illustrated in FIG. 13.

FIG. 14, shows a flow chart illustrating the data processing operations carried out when the help function relating to a control element is invoked. The overall handling of the pointer device event is the same as that described previously with reference to FIGS. 5 and 8. The process 400 begins at step 402 and at step 404 a ‘?’ shaped gesture is detected over a control element. Then at step 405, all of the 2D gestures 382 associated with the control element 380 and controls 392 labelled with the functions are displayed adjacent and around the control element. At step 406 it is determine in what manner the user has selected to execute a one of the functions. The user can apply a 2D gesture to the control element, or draw a mark from the control element to a labelled control or click on a one of the labelled control. If not of these command entry mechanisms are detected then process flow returns 408 to step 405 to await a correct command entry. Then at step 410 the command selected by a one of the correct entry mechanisms is executed. The help process 400 then terminates at step 412.

FIG. 15 shows a further example of a control element 420 which can be used in the user interface of the present invention. This control element 420 is adapted to be easily distinguishable by a users peripheral vision and so can be placed in a user interface in a peripheral region rather than in the users main field of view. By carefully choosing the animation of the control element the functionality can be improved by reducing its intrusiveness and elegantly increasing the prominence of the control element. Animated control elements effectively broaden the visual field. Control elements that can be interpreted with peripheral vision, facilitate unobtrusive redundancy and the adaptivity of smart interface controls. This approach thus improves the functionality of an adaptive mechanism by easing its intrusiveness and elegantly increasing the prominence of control elements.

The peripherally interpretable control element 420 shown in FIG. 15 is a device consisting of an animated transparent graphical layer that features alternating bands of light and dark colour progressing over its surface. The thickness of the bands vary as they progress along an animation axis 422 of the control element. The orientation of the device is indicated by the direction of the progressive bands of light and dark along the animation axis of the control element. The control element can also rotate as illustrated by arrows 421. The animated bands provide a sense of orientation or direction of the control element. The control element can be used to provide a “dial” by using the animation axis as a “pointer” and wherein the control element rotates, to the left or right, so as to indicate a change in a condition.

This control element is suited to interpretation via peripheral vision. Users have little difficulty reading the control element through the corner of their eye. The user can quite easily view the background and the superimposed control element 420 which eliminates the cognitive interruption associated with the redirecting of gaze. Thus, the field of vision of the user is effectively broadened. This could be particularly useful for an in car navigation system or speedometer, a download progress indicator or even status indicator for a critical system or computer game.

A further control element can be provided which has a cognitively ergonomic design heuristic, which avoids interruptions of attention caused by intrusive dialogues that often obscure the underlying display. For example, conventional submenus cause a high short-term memory load through the obscuring of the underlying work context and the visual search overhead when the user is required to select from a large list of options. A control element can be provided that reduces both memory load and visual scanning of items by providing a menu system wherein drawing a letter over a menu control element, such as menu title or menu button, collects all the commands from that menu beginning with the appropriate letter. For example drawing an “o” gesture over a file menu control element would collect together and display all commands or functions beginning with “o” in that menu. Hence, the system groups these commands together in a smaller, easier to handle, menu which is displayed to the user. In some cases there may only be one item in the list, thereby dramatically reducing the necessary visual search. Hence, this control mechanism effectively has a built in search functionality.

A further approach to improving the visual distinguishability of the control elements is to animate the control elements so that they appear to be three dimensional entities. This can be achieve in a number of ways. For example, a control element can be animated so that it appears to be a rotating three dimensional object, e.g. a box. Alternatively, shading can be used to give the control element a more three dimensional appearance. This helps the human visual system to pick the control element out from the ‘flat’ background and also allows the control elements to be made more transparent than a control element that has not been adapted to appear three dimensional.

A further control element that could be used in the user interface of the present invention, is a control element for providing a scroll functionality. This would increase the area available for display as it would remove the scroll bars typically provided at the extreme left or right and top or bottom of a window. The gestures associated with the overloaded control element can determine both the direction and magnitude of the scrolling operation to be executed. The amount of scrolling can be proportional to the extent of the 2D gesture in the direction of the gesture. Further, the direction of scrolling can be the same as the direction of the 2D gesture. For example, a short left going gesture made over the control element results in a small scroll to the left, and a long downward gesture made over the control element results in a large downward scroll.

A further control element could be made to be dependent on a combination of gesture and keyboard, or other input device, entry in order to execute some or all functions. For example a control element could be used to close down or reset a device. In order to provide a failsafe mechanism. The function associated with the gesture is not executed unless a user is also pressing a specific key, or key combination, on the devices keyboard at the same time. For example a soft reset of a device, could require a user to make a “x” gesture over the control element while also having the “CTRL” key depressed. Hence this would help to obviate incorrect gesture parsing, recognition or entry from accidentally causing harm. Further different combinations of keyboard keys and the same gesture could be used to cause different instructions to be executed. Hence, keyboard entries and gestures could be combined to provide “short cuts” to selecting and executing different functions.

A further control element uses the semantic content of a gesture to ensure that the correct option or operation is carried out. For example a control element could display a message and two options, for example “delete file” and the options “yes” and “no”. In order to execute the delete file operation, the user must make the correct type of mark which is conceptually related to the selected option. In this example, the user would make a “tick” mark to select yes, and a “cross” mark to select no. This would help prevent accidental selection of the incorrect option as can happen currently when a user simply clicks on the wrong option by accident. The control element can further be limited by requiring that the correct gesture be made over the corresponding region of the option of the control element. Hence, if a tick were made over the “no” option, then the command would not be executed. Only making a tick over the region of the control element associated with the “yes” option would result in the command being executed. This provides a further safe guard.

The methods and techniques of the current invention can be applied to user interfaces for many electrical devices, for example to support interaction for Databoards, public information kiosks, small devices, such as wearable devices and control dashboards for augmented and virtual reality interfaces. The keyboard aspect can be extended by the use of predictive text. For example, the specific first letter of a word can be entered using a gesture and a further gesture is used to define the length of the word. Successive groups of letters are then tapped on, (as with the T9 dictionary), to generate a list of possibilities. Also it is possible to enter specific letters in order to refine to search.

There are other applications and developments of the principles taught herein. For example, it has been found that users can perceive controls with indirect gaze making the model useful in peripheral displays, adaptive systems and designing interaction for the visually impaired, such as people who lose all sight other than peripheral vision. Adaptive displays could also benefit from the freedom to place new items or reconfigure displays without upsetting the layout of controls.

Another property is, that elements sharing the same motion appear grouped together. This approach can be used to implement widely dispersed menu options on a display without the necessary overhead of bounding them in borders, as is usually required to suggest a group relationship.

Further control elements can be designed benefiting from theories of perception. Such adaptations of the control elements will help to minimise, and govern the effects of, visual rivalry, by introducing 3D control elements and dynamic shading of control elements.

Generally, embodiments of the present invention employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

Although the above has generally described the present invention according to specific processes and apparatus, the present invention has a broad range of applicability. In particular, aspects of the present invention is not limited to any particular kind of electronic device. One of ordinary skill in the art would recognize other variants, modifications and alternatives in light of the foregoing discussion.

It will also be appreciated that the invention is not limited to the specific combinations of structural features, data processing operations, data structures or sequences of method steps described and that, unless the context requires otherwise, the foregoing can be altered, varied and modified. For example different combinations of features can be used and features described with reference to one embodiment can be combined with other features described with reference to other embodiments. Similarly the sequence of the methods step can be altered and various actions can be combined into a single method step and some methods steps can be carried out as a plurality of individual steps. Also some of the features are schematically illustrated separately, or as comprising particular combinations of features, for the sake of clarity of explanation only and various of the features can be combined or integrated together.

It will be appreciated that the specific embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description.

1. A user interface for a display of an electronic device, the user interface including:
a background layer for displaying an interface; and
at least a first animated control element overlaid on the back ground layer, wherein the control element has a plurality of functions associated with it and each of said functions being executable by making a 2D gesture associated with a one of said plurality of functions in a region of the user interface associated with the control element.

2. A user interface as claimed in claim 1, wherein the control element moves over a region of the display.

3. A user interface as claimed in claim 1 or claim 2, wherein the control element is an icon.

4. A user interface as claimed in claim 1 or 2, wherein the control element is an alphanumeric string.

5. A user interface as claimed in claim 4, wherein the alpha numeric string is a word.

6. A user interface as claimed in claim 5, wherein the word is polysyllabic and the each individual syllable is animated.

7. A user interface as claimed in claims 1 or claim 2, wherein the control element is a button.

8. A user interface as claimed in claim 7, wherein the button bears and indicia indicating a menu of functions associated with the button and wherein making the 2D gesture executes a function from the menu.

9. A user interface as claimed in any preceding claim, wherein a help function is associated with the control element and wherein making a help 2D gesture causes help information relating to the functions associated with the control element to be displayed in the user interface.

10. A user interface as claimed in claim 9, wherein the help 2D gesture has the shape substantially of a question mark.

11. A user interface as claimed in any preceding claim, wherein the control element is visually opaque.

12. A user interface as claimed in any of claims 1 to 10, wherein the control element is visually transparent.

13. A user interface as claimed in claim 12, wherein the control element has a transparency of less than substantially 30%.

14. A user interface as claimed in any preceding claim, wherein the user interface includes a plurality of animated control elements.

15. A user interface as claimed in claim 14, wherein the first control element is of a first type and a second of the plurality of control elements is of a second type, which is different to the first type.

16. A user interface as claimed in claim 14 or 15, wherein the plurality of control elements between them provide a keyboard.

17. A user interface as claimed in claim 16, wherein the keyboard has a standard layout.

18. A user interface as claimed in claim 16 or 17 wherein the keyboard provides all of the characters in an alphabet of a language.

19. A user interface as claimed in any of claims 16 to 18, wherein at least one of the control elements is associated with a plurality of characters and each of the plurality of characters has a respective 2D gesture associated therewith for causing the character to be displayed on the background layer.

20. A user interface as claimed in any preceding claim wherein the control element has a 2D gesture associated with it for carrying out a formatting function on a character associated with the control element.

21. A user interface as claimed in any of claims 1 to 15, wherein at least one control elements is associated with a plurality of media player functions and each of the media player functions has a respective 2D gesture associated therewith for causing the media player function to be executed.

22. A user interface as claimed in any preceding claim, wherein the control element is animated so as to appear like a three dimensional entity.

23. A user interface as claimed in any preceding claim, wherein the control element is animated so as to be more readily noticeable by peripheral vision.

24. A user interface as claimed in claim 23, wherein the control element has an axis along which it is animated.

25. A user interface as claimed in claim 24, wherein the control elements animation comprises variable thickness bars scrolling along the axis.

26. An electronic device having a user interface, the electronic device including:
a display device;
a data processing device; and
a memory storing instructions executable by the data processing device to display the user interface on the display, wherein the user interface is as claimed in any preceding claim.

27. A device as claimed in claim 26, wherein the display is a touch sensitive display.

28. A device as claimed in claim 26 or 27, wherein the device further includes a pointer device for making a 2D gesture on the user interface.

29. A device as claimed in any of claims 26 to 28, wherein the device is a handheld device.

30. A device as claimed in any of claims 26 to 29, wherein the device is a wireless telecommunications device.

31. A device as claimed in claim 30, wherein the device is a cellular telecommunications device.

32. A computer implemented method for providing a user interface for a display of an electronic device, comprising:
displaying an interface as a background layer;
displaying an animated control element associated with a plurality of functions over the background layer;
detecting a 2D gesture made over a region of the user interface associated with the control element; and
executing a one of the plurality of functions which is associated with the 2D gesture.

33. A method as claimed in claim 32, wherein a plurality of animated control elements are displayed.

34. A method as claimed in claim 32 or 33, wherein the animated control elements are transparent.

35. A method as claimed in any of claims 32 to 34 and wherein detecting the 2D gesture further comprises a gesture engine parsing the 2D gesture and generating a keyboard event corresponding to the 2D gesture.

34. A method as claimed in any of claims 32 to 35, and further comprising determining a location within the display of the 2D gesture and determining whether a control element is associated with the location.

35. A method as claimed in any of claims 32 to 35, and further comprising: determining whether a gesture is intended to activate a control element and if not then determining a function of the background layer to execute.

36. A method as claimed in claim 32, wherein the 2D gesture is a help 2D gesture and the function associated with the 2D gesture is a help function which displays information relating to the control element.

37. A method as claimed in claim 36, wherein the information relating to the control element includes a graphical indication of the 2D gestures associated with the control element and/or text explaining the functions associated with the 2D control element.

38. A method as claimed in claim 32, wherein the control element is associated with a menu of functions and wherein the 2D gesture causes a one of the functions from the menu of functions to be executed.

39. A method as claimed in claim 33 wherein the plurality of control elements between them provide a key board and wherein the 2D gesture causes a character selected from the keyboard to be displayed on the background layer.

40. A method as claimed in any of claims 32 to 39 wherein the control element is a character string.

41. A method as claimed in claim 40, wherein the character string is a word.

42. A method as claimed in claim 41, wherein the word is a polysyllabic word and each syllable of the word is separately animated.

43. Computer program code executable by a data processing device to provide the user interface of any of claims 1 to 25 or the computing device of any of claims 26 to 31 or the method of any of claims 32 to 40.

44. A computer program product comprising a computer readable medium bearing computer program code as claimed in claim 43.
